(19) United States
(12) Patent Application Publication
(10) Pub. No.: US 2007/0260672 A1
(43) Pub. Date: Nov. 8, 2007

(54) A POST/BIOS SOLUTION FOR PROVIDING INPUT AND OUTPUT CAPACITY ON DEMAND

(75) Inventors: Jason R. Almeida, Raleigh, NC (US); Scott N. Dunham, Raleigh, NC (US); Eric R. Kern, Chapel Hill, NC (US); William B. Schwartz, Apex, NC (US); Adam L. Soderlund, Bahama, NC (US)

Correspondence Address: CANTOR COLBURN LLP - IBM RESEARCH TRIANGLE PARK, 55 GRIFFIN ROAD SOUTH, BLOOMFIELD, CT, 06002, US

(73) Assignee: International Business Machines Corporation, Armonk, NY (US)

(21) Appl. No.: 11/382,138

(22) Filed: May 8, 2006

(51) Int. Cl. G06F 15/16; G06F 15/177

(52) U.S. Cl. 709/203; 713/1

(57) ABSTRACT

Basic server resources may be extended by the completion of a Capacity on Demand (CoD) Agreement. The CoD Agreement provides authorization to the server for activation of inactive resources. A Power On Self Test (POST) works in conjunction with a system management interrupt, a memory unit, and a plurality of Peripheral Component Interconnect (PCI) host bridges to provide for on demand additions of input and output adapters. The adapters may be added during various phases of operation and may be hot pluggable.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to management of components and resources for a computer network server and particularly to activation of inactive and extended resources.

2. Description of the Related Art

One example of a prior art technique is disclosed in U.S. Pat. No. 6,301,604 B1, entitled “File Array Storage Architecture Having File System Distributed Across a Data Processing Platform,” issued Oct. 9, 2001, to Napolitano, et al. This patent discloses a file array storage architecture having a file system that is distributed across a data processing platform. The patent discloses an architecture that enables implementation of the file system in a modified client-server computing model.

Another example of a prior art technique is disclosed in U.S. Pat. No. 5,758,144, entitled “Database Execution Cost and System Performance Estimator,” issued May 26, 1998, to Eberhard, et al. This patent discloses a software tool that estimates the costs of an application program accessing a database. The patent discloses a tool that receives simplified and partial definitions of tables, utilities, SQL statements, transactions, and applications.

A recent technique for managing server resources calls for inactivating portions thereof, and calling upon the additional capacity when needed. In some embodiments, “Capacity on Demand” (CoD) encompasses the various capabilities that allow users to dynamically activate one or more resources on a server as business needs dictate. Inactive processors and memory units that are resident in the server can be activated on a temporary and permanent basis.

Exemplary servers providing Capacity on Demand functionality include IBM System i5™ and eServer™ i5 and E3M System p5™ and eServer p5 520, 550, 570, 590, and 595 models. Some of these and other servers include a number of active and inactive resources.

As a matter of convention, the active processors and active memory units are resources that are available for use on the server when it comes from the manufacturer, while the inactive processors and inactive memory units are resources that are included with the server, but not available for use until activated by the user.

In the Capacity on Demand (CoD) architecture, inactive processors and memory units can be temporarily or permanently activated by purchasing an activation feature and entering an activation code. Controls over the capacity are typically governed by a seller/user agreement that dictates the availability of resources. This agreement is referred to as the CoD Agreement.

The Capacity on Demand concept can be taken further, and extended to other server resources. Input and output (I/O) Capacity on Demand is an area requiring further development. One method to add I/O capacity when needed does exist in the form of I/O hot plug (such as PCI-X hot pluggable slots). However, this I/O capacity upgrade does not contain a method for the manufacturer to control the enablement of the hot plugged device.

What are needed are Capacity on Demand (CoD) architecture enhancements to provide for managing calls for increased input and output resources.

### SUMMARY OF THE INVENTION

The shortcomings of the prior art are overcome and additional advantages are provided through the provision of a computer program product stored on machine readable media having instructions for enabling resources in a server, the server having a plurality of Peripheral Component Interconnect (PCI) host bridges (PHB) and a plurality of adapter slots associated with the PHB, the product having instructions for performing a power-on-self-test (POST); setting resource ranges for the resources; creating resource range information for use by an operating system; and, placing system management interrupt instructions into memory of the server for enabling an authorized resource.

Also disclosed is a computer server having a computer program product having instructions for enabling resources in the server, the server having a plurality of Peripheral Component Interconnect (PCI) host bridges (PHB) and a plurality of adapter slots associated with the PHB, the product having instructions for: performing a power-on-self-test (POST); setting resource ranges for the resources; creating resource range information for use by an operating system; and, placing system management interrupt instructions into memory of the server for enabling an authorized resource.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which includes a computer program product stored on machine readable media having instructions for enabling resources in a server, the server having a plurality of Peripheral Component Interconnect (PCI) host bridges (PHB) and a plurality of adapter slots associated with the PHB, the product having instructions for performing a power-on-self-test (POST), wherein performing the POST has creating a list of authorized resources; authorizing at least one of the resources; wherein authorizing the resource means entering an authorization code upon completion of an agreement; setting resource ranges for the resources; creating resource range information for use by an operating system; and, placing system management interrupt instructions into memory of the server for enabling an authorized resource, wherein enabling the authorized resource has associating a resource register with the authorized resource; wherein upon the insertion of an adapter into one of the adapter slots, the adapter is enabled only if one of the adapter and the adapter slot is one of the authorized resources referenced in the list of authorized resources; determining if a hot-plugged resource is an authorized resource; and enabling the hot-plugged resource if the hot-plugged resource is an authorized resource.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of memory address resource flow; and

FIG. 2 illustrates one example for managing adapter slot capacity on demand.

The detailed description explains the preferred embodiments of the invention, together with advantages and features, by way of example with reference to the drawings.

### DETAILED DESCRIPTION OF THE INVENTION

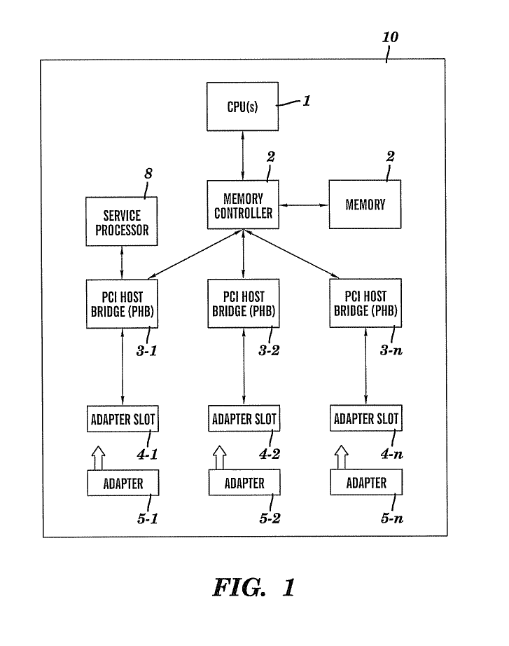

Referring now to FIG. 1 aspects of a server 10 are shown. In this embodiment, the server 10 includes, among other things, at least one central processing unit (CPU) 1; at least one memory unit 2 (wherein the memory unit 2 typically includes at least one memory controller and memory bank); and a plurality of Peripheral Component Interconnect (PCI) Host Bridges (PHB) 3. Each of the PHB 3 is associated with an adapter slot 4 from a plurality of adapter slots 4. Each of the adapter slots 4 provides input/output (I/O) access for various peripheral resources (not depicted) to resources of the server 10. Communications within the server 10 typically occur via pathways depicted by the arrows. A plurality of adapters 5 are made available as needed for plugging into the adapter slots 4. In this embodiment, a service processor 8 is included. The service processor 8 typically provides for various system management functions, some of which are described herein. As discussed herein, the service processor 8 provides a subsystem for managing aspects of authorization of adapter slots 4 and adapters 5.

Of course, the diagram of the server 10 is vastly oversimplified. Many other functions and features are known to those skilled in the art. Salient aspects of some of those functions and features include a “POST” which is a Power On Self Test (System BIOS configuration and initialization prior to booting of an operating system); an “SMI” or System Management Interrupt (a mode for the CPU 1 in which code placed in the memory unit 2 during POST executes without involvement of the operating system, the operating system being on hold during this time); and a “MMIO” or Memory Mapped Input Output (a memory address space used to access a device rather than the memory unit 2).

In the Capacity on Demand (CoD) architecture, a portion of the plurality of adapter slots 4 is typically available for use and provide for basic server operation. A remaining number of the adapter slots 4 are not enabled until a CoD Agreement has been completed. For convenience, these remaining adapter slots 4 (or other features subject to activation by fulfillment of the CoD Agreement) may be referred to as “extended.”

In the Capacity on Demand architecture, extended features (such as inactive processors 1 and memory units 2) can be activated by purchasing an activation feature. Typically, activation is one of temporary or permanent and calls for entering an activation code. Controls over the activation of features are typically governed by a seller/user Capacity on Demand (CoD) Agreement that dictates the availability of resources. Multiple CoD Agreements may be had to provide for incremental activation of system components.

Consider now typical techniques for activation of system components. Typically, a POST/SMI handler is used to identify (receive notification) regarding a completed CoD Agreement. Notification typically occurs via the service processor 8. The service processor 8 will be queried about the status of the CoD Agreement during each POST. Once the operating system has loaded, the service processor 8 will force a system management interrupt to inform a system management interrupt handler of a completed CoD agreement.

Management of the adapter slots 4 is subject to the Capacity on Demand (CoD) Agreement typically occurs via one of two methods. In a first embodiment, controls are placed upon use of each of the adapter slots 4. In a second embodiment, controls are placed upon adapters 5 placed into the adapter slots 4.

In the first embodiment, where each of the adapter slots 4 are controlled, the adapter slot 4 does not become functional until specified by the CoD Agreement. Various techniques may be used for management of the adapter slots 4 in this embodiment.

For example, if the adapter slot 4 is not hot-pluggable (supportive of an addition of an adapter 5 and immediate enabling of the adapter 5 during system operation), the POST will only enable the adapter slot 4 if the service processor 8 indicates this is appropriate per the CoD Agreement.

If the adapter slot 4 is hot-pluggable, the POST will typically reserve resources for each hot-pluggable adapter slot 4 (PCI bus numbers, MMIO space, IO space, etc.) but not enable access to these resources through the PCI Host Bridge 3 associated with the respective adapter slot 4. If a hot plug attempt occurs, or if an adapter 5 is plugged into the adapter slot 4 at power up, prior to an upgrade to the CoD Agreement, the PCI Host Bridge 3 will not allow the adapter 5 in the adapter slot 4 to access resources. Accordingly, the adapter 5 will be prevented from operation.

The prevention occurs as neither the operating system nor software components (such as hot plug drivers) are provided information for programming resource ranges in the respective PCI Host Bridge 3. This is the case since specification for the Peripheral Component Interconnect (PCI) (PCI) does not specify a format of PCI Host Bridge 3 resource range registers.

Once an upgrade to the CoD Agreement has been completed, the service processor 8 will force one of the system management interrupts to notify the system management interrupt handler of the adapter slot 4 that is now legitimately available. The system management interrupt handler will enable the resource ranges in the PCI Host Bridge 3 to support a subsequent operational addition (referred to as a “hot addition”) of an adapter 5 in the adapter slot 4. If the adapter 5 was already installed (but disabled) prior to operating system boot, the system management interrupt handler will simulate a hot add event to immediately enable operation of the adapter 5.

In the second embodiment, where controls are placed upon adapters 5 for placement into adapter slots 4, the service processor 8 maintains a list of authorized (paid for) adapters 5. Typically, the list of authorized adapters 5 is maintained using various identifiers, such as the Vendor, Device, and Subsystem IDs. The POST will query the service processor 8 for the list of authorized adapters. Only the adapters 5 on the list of authorized adapters will be enabled. In typical embodiments, adapter slots 4 not containing authorized adapters will have resources reserved, but the adapter slot 4 will not be enabled. These adapter slots 4 may be managed according to an adapter slot management scheme (such as in the first embodiment above).

When an adapter 5 is hot plugged to one of the adapter slots 4, the system management interrupt will determine Subsystem ID configuration registers and query the service processor 8. The service processor 8 will test the adapter 5 against the list of authorized adapters. If the adapter 5 is authorized, resource ranges for the PCI Host Bridge 3 will be enabled by the system management interrupt handler and control will pass to software components for the adapter 5 (such as the hot plug driver). If the adapter 5 is not authorized, the system management interrupt handler will not enable the ranges and an attempt to hot plug the adapter 5 will fail. The system management interrupt handler will keep a list of installed and disabled adapters 5 and corresponding adapter slots 4 for each. When the CoD Agreement is completed for one of the disabled adapters 5, the service processor 8 will provide notification to the system management interrupt handler and the system management interrupt handler will enable the appropriate adapter slot 4. Once completed, the system management interrupt handler will force the hot plug event as in the first embodiment above.

Aspects of memory address resource management are now presented. Consider the memory partitioning scheme presented in Table 1. In this scheme, a memory location is addressed by the CPU 1, and some of the memory addresses go to physical memory in the memory bank. Other memory addresses go to input and output devices through a PHB 3.

TABLE 1
Memory Partitioning

| | |
|---|---|
| Upper system memory | 4 G-16 G |
| PHBx | 3.5 G-4 G |
| PHBy | 3.25 G-3.5 G |
| PHBz | 3 G-3.25 G |
| Lower system memory | 0-3 G |

Memory address space is just one of the resources assigned to input and output devices. Therefore, memory addressing is merely illustrative of the teachings herein and provide for an indication of the method. Other resources include input and output space, PCI Bus numbers, interrupts, and others. Typically, the PHBs 3 contain resource range registers and optionally range enable/disable bits to control the resource flow to the associated adapter slot 4. Although aspects of devices such as the adapters 5 and adapter slots 4 typically have well defined (per industry standard specifications) resource register assignments, the PCI Host Bridge 3 does not. Therefore, in the CoD architecture, the POST (and SMI) code maintains information regarding the appropriate resource register locations for programming the PHB 3, but the operating system does not.

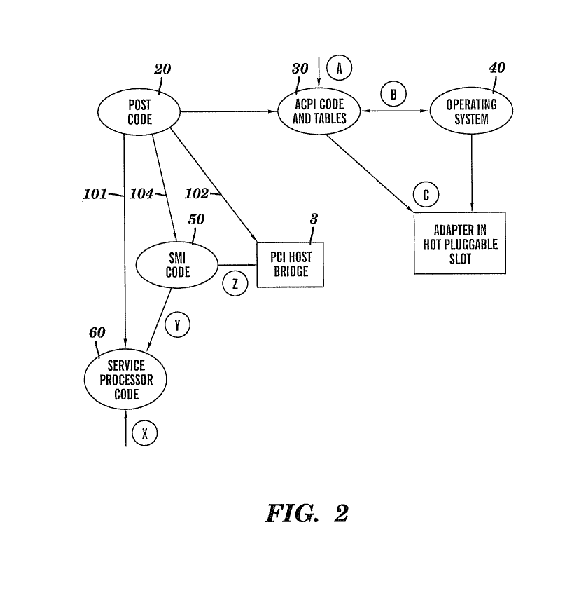

The flow diagram of FIG. 2 illustrates aspects of the events for setting up of the resource ranges. Note that in FIG. 2, certain components of the teachings herein are depicted. For example, the POST 20, the ACPI code and tables 30, the operating system 40, the system management interrupts (SMI) 50, as well as service processor code 60. With these references, consider the following events for controlling flow 100 of input and output adapter in the CoD architecture.

First, during power on, POST queries the service processor 8 for the list of authorized adapters in a POST query 101. For example, the list includes adapters 5 that are permitted for use according to a CoD Agreement and are identified by the Vendor ID/Device ID. Typically, the identification involves industry standard PCI device configuration information and techniques.

Next, the resource ranges for the plurality of PCI Host Bridge 3 are set up. Setting resource ranges 102 accounts for installed adapters 5 and reserved space for hot pluggable slots where no adapter 5 is installed. In setting resource ranges 102, the PHBs 3 associated with installed and unauthorized adapters have their resource ranges disabled. Disabling typically occurs either via a range disable bit or by creating an invalid range (hardware dependent).

After setting resource ranges 102, ACPI code and tables are created by POST and placed into memory for later use by the operating system. In code and table creation 103, resource range information for each PHB 3 is typically included to provide for hot plug support.

Following code and table creation 103, loading SMI code 104 occurs. The SMI code is placed by POST into memory for later use (outside of the context of the operating system). The list of authorized adapters is provided to the SMI handler. For systems containing hardware lacking range disable bits, the reserved resource range information is given to the SMI handler for those PHBs 3 controlling disabled slots (disabled due to lack of purchase).

Referring also to FIG. 2, consider when the adapter 5 is added to the operational adapter slot 4 (i.e., “hot plugged”). This is denoted by “A” in FIG. 2. When hot plugging is initiated, the SMI code that has been set up to be triggered when a hot plug event occurs is invoked. This is denoted by “B” in FIG. 2. The SMI code reads the Vendor ID/Device ID of the hot plugged adapter 5 (this can be done prior to resource assignment) and disables the PHB resource range of the adapter 5 if the adapter is not on the list of authorized adapters. The SMI code then invokes the ACPI code. The ACPI and the operating system code is executed in response to the hot plug event. At this point, resources are assigned by at least one of the ACPI and operating system to the adapter 5. The ranges assigned typically fall within the resource range of the PHB for that slot. This is denoted by “C” in FIG. 2. It should be noted that if the resource range for the PHB 3 has not been enabled by POST or SMI, the hot plugged adapter 5 will not work.

Further with reference to FIG. 2, consider aspects of establishing the list of authorized adapters and establishing valid CoD Agreements. As denoted by the “X” in FIG. 2, an indication that an adapter 5 has been authorized (i.e., purchased) is typically sent (e.g. over Ethernet) to the service processor 8. In response, the service processor 8 forces a system management interrupt (SMI) to occur. As denoted by the “Y” in FIG. 2, the SMI code 50 receives information for the newly purchased adapter 5 and updates the list of authorized adapters. As denoted by the “Z” in FIG. 2, the SMI code 50 also enables the resource range for the corresponding PHB 3 (such as in the case where the adapter 5 was installed at power on, yet had been disabled since the adapter 5 was not previously authorized).

Note that if the newly enabled adapter 5 is already installed in a hot-pluggable adapter slot 4, the SMI code 50 will force a hot plug event to occur so that the operating system 40 and ACPI code 30 can enable the adapter 5. Further, if the newly enabled adapter 5 is already installed in a non-hot pluggable slot, the installed adapter 5 will not be enabled until the next reboot of the server 10. Also, if the newly enabled adapter 5 is not yet installed, the SMI handler or POST will enable the adapter 5 upon the hot plug event (if the adapter 5 is added during operation of the operating system 40 to one of the hot pluggable adapter slots) or upon reboot of the server 10 (since the adapter 5 is now on the list of authorized adapters).

Aspects of the capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer program product stored on machine readable media comprising instructions for enabling resources in a server, the server comprising a plurality of Peripheral Component Interconnect (PCI) host bridges (PHB) and a plurality of adapter slots associated with the PHB, the product comprising instructions for:
performing a power-on-self-test (POST);
setting resource ranges for the resources;
creating resource range information for use by an operating system; and,
placing system management interrupt instructions into memory of the server for enabling an authorized resource.

2. The computer program product of claim 1, wherein performing the POST comprises creating a list of authorized resources.

3. The computer program product of claim 1, wherein upon the insertion of an adapter into one of the adapter slots, the adapter is enabled only if one of the adapter and the adapter slot is one of the authorized resources.

4. The computer program product of claim 1, further comprising instructions for authorizing at least one of the resources.

5. The computer program product of claim 4, wherein authorizing the resource comprises entering an authorization code.

6. The computer program product of claim 4, wherein completing an agreement comprises providing the authorization code.

7. The computer program product of claim 1, wherein identifying authorized resources comprises referencing a list of authorized resources.

8. The computer program product of claim 1, wherein enabling the authorized resource comprises associating a resource register with the authorized resource.

9. The computer program product of claim 1, wherein the resources further comprise at least one adapter.

10. The computer program product of claim 1, further comprising instructions for:
determining if a hot-plugged resource is an authorized resource.

11. The computer program product of claim 1, further comprising instructions for:
enabling a hot-plugged resource if the hot-plugged resource is an authorized resource.

12. A computer server comprising a computer program product having instructions for enabling resources in the server, the server comprising a plurality of Peripheral Component Interconnect (PCI) host bridges (PHB) and a plurality of adapter slots associated with the PHB, the product comprising instructions for:
performing a power-on-self-test (POST);
setting resource ranges for the resources;
creating resource range information for use by an operating system; and,
placing system management interrupt instructions into memory of the server for enabling an authorized resource.

13. The computer server of claim 12, wherein performing the POST comprises creating a list of authorized resources.

14. The computer server of claim 12, further comprising instructions for generating an authorization code.

15. A computer program product stored on machine readable media comprising instructions for enabling resources in a server, the server comprising a plurality of Peripheral Component Interconnect (PCI) host bridges (PHB) and a plurality of adapter slots associated with the PHB, the product comprising instructions for:
performing a power-on-self-test (POST), wherein performing the POST comprises creating a list of authorized resources;
authorizing at least one of the resources; wherein authorizing the resource comprises entering an authorization code upon completion of an agreement;
setting resource ranges for the resources;
creating resource range information for use by an operating system; and,
placing system management interrupt instructions into memory of the server for enabling an authorized resource, wherein enabling the authorized resource comprises associating a resource register with the authorized resource;
wherein upon the insertion of an adapter into one of the adapter slots, the adapter is enabled only if one of the adapter and the adapter slot is one of the authorized resources referenced in the list of authorized resources;
determining if a hot-plugged resource is an authorized resource; and
enabling the hot-plugged resource if the hot-plugged resource is an authorized resource
